(19) United States
(12) Patent Application Publication
(10) Pub. No.: US 2007/0267039 A1
(43) Pub. Date: Nov. 22, 2007

(54) ULTRASONIC CLEANER

(76) Inventor: Jerry Sullivan, Richfield, OH (US)

Correspondence Address: KATTEN MUCHIN ROSENMAN LLP, 575 MADISON AVENUE, NEW YORK, NY, 10022-2585, US

(21) Appl. No.: 11/750,654

(22) Filed: May 18, 2007

Related U.S. Application Data
(60) Provisional application No. 60/801,787, filed on May 19, 2006.

(51) Int. Cl. B08B 3/12; B08B 3/00; B08B 7/04

(52) U.S. Cl. 134/1; 134/56 R; 134/105; 134/184; 134/18

(57) ABSTRACT

An ultrasonic cleaner is provided with a user interface, display, and a solution timer unit that tracks the amount of time cleaning solution has been in use. The solution life is displayed in hours and minutes that can be adjusted or reset by an operator. The ultrasonic cleaner includes a solution reset key conspicuously located on a control panel that is mounted on a housing of the ultrasonic cleaner. An operator may periodically check how long the solution has been in use by simply looking at a screen displaying the time elapsed since the beginning of the period. The display may also indicate cleaning cycle times and status, such as the completion of a cleaning cycle; and the user interface may allow the operator to set cleaning cycle parameters, such as cleaning cycle time.

### CROSS-REFERENCE TO RELATED APPLICATIONS

This application claims the benefit of U.S. Provisional Patent Application 60/801,787, filed May 19, 2006, which is incorporated herein by reference.

### BACKGROUND OF THE INVENTION

1. Field of the Invention

The present invention relates to ultrasonic cleaners operative to clean dental or medical instruments, dentures, optical lenses, eyeglasses, and to a method for operating such cleaners.

2. Prior Art

Professionals in the dental, laboratory and medical fields use ultrasonic systems to clean instruments, apparatus, labware, crowns, dentures and other devices prior to sterilization. Ultrasonic cleaning greatly reduces the risk of cross-contamination and infection that can occur with other types of cleaning. Hence this procedure is critical in protecting instruments and is at the center of infection risk control.

Ultrasonic cleaners use high frequency sound waves propagating in aqueous solutions that create bubbles that loosen and remove impurities from items to be cleaned. A typical ultrasound cleaner is configured with a housing defining a bath filled with a cleaning solution that is agitated by high frequency sound waves sufficient to create and burst up bubbles that remove impurities from instruments. An example of such an ultrasonic cleaner is disclosed in U.S. Design Pat. No. 315,040 fully incorporated herein by reference. Other examples of ultrasonic cleaners are disclosed in U.S. Pat. No. 4,903,718 also incorporated herein by reference.

A cleaning solution utilized in the ultrasound cleaner configured with a bath is typically reused and, thus, tends to lose its effectiveness long before the bath is refilled with a new volume of the solution. Consequently, it is important that an operator keep track of how long the solution has been used and replace it in a timely manner.

Typically, the ultrasound cleaner is used repeatedly during the day. A cleaning cycle may last a few minutes or longer depending on the selected cycle time period. In certain situations, knowing how much time is left before the cycle is completed is important. However, the known devices may lack a visual indicating means that would provide such information.

With the global economy expanding, many of the known ultrasound devices can be purchased all over the world. At least some of the known devices utilize a user display providing an operator with easily seen step-by-step operational instructions. Yet, the known devices may have limited communication capabilities and display instructions in a language unfamiliar to the operator. Accordingly, the marketability of such devices may suffer from a lack of comprehension. Still other devices are specifically manufactured to meet the linguistic requirements of the regions or countries to which these devices are exported. This, in turn, incurs unnecessary expenses on both manufactures and consumers.

It is, therefore, desirable to provide an ultrasonic cleaner that has the capability of providing the operator with an indication of how long the solution has been used.

Also, it is desirable to provide an ultrasonic cleaner that has the capability of displaying the time remaining to complete a current cleaning cycle.

Furthermore, it is desirable to provide an ultrasonic cleaner that has the ability to have operational instructions displayed in several different languages.

Finally, it is desirable to provide an ultrasonic cleaner that has a control panel allowing the operator to utilize the cleaner in a simple and comprehensive manner.

### SUMMARY OF THE INVENTION

The present invention meets these needs and seeks to provide an ultrasonic cleaner provided with a solution timer unit that tracks the amount of time the solution has been in use. The solution life is displayed in hours and minutes that can be adjusted or reset by the operator. Preferably, the solution timer unit comprises a solution reset key conspicuously located on a control panel that is mounted on the housing of the inventive ultrasonic cleaner. After having set the desired solution life period, the operator may periodically check how long the solution has been in use by simply looking at a screen displaying the time elapsed since the beginning of the period. Optionally, the solution timer unit is operative to display the time left before the set period expires on the screen. A warning signal may be generated by the solution timer unit to alert the operator that either the desired solution life period has just expired or will expire in a predetermined period of time.

The benefits of utilizing the solution timer are numerous. Firstly, the cleaner is typically most effective when the solution is fresh and clean. Secondly, periodic changes of the solution minimize the possibility that it would evaporate below the low threshold level over a period of time and, thus, detrimentally affect the effectiveness of the cleaning process and damage the cleaner. Thirdly, the operator of the inventive cleaner does not have to remember and periodically check when the solution was changed or added last which facilitates the operator's job.

In accordance with another aspect of the invention, the inventive ultrasonic cleaner is operative to indicate how much time is left before the end of the user-selected cleaning cycle. To implement this feature, the inventive cleaner is provided with a count-down timer operative to indicate the remaining time on the screen.

At least one of the benefits of the count-down timer includes facilitating the operator's job. Knowing the remaining time, the operator may attend to other tasks and schedule his time in a manner convenient to him or her.

A further aspect of the invention relates to a language-selection unit of the inventive ultrasonic cleaner that is operative to communicate with the operator at the language selected by the operator. The inventive cleaner, thus, is operative to provide written and, optionally, audible messages in the language easily understood by the operator.

The language-selection unit improves the marketability of the inventive cleaner. It also may eliminate the necessity of reconfiguring an ultrasound cleaner when the latter is exported to or purchased in a foreign country speaking in a language different from the country where the cleaner is manufactured.

The inventive ultrasonic cleaner is computerized. Software executed by a central control unit, such as a processor, is operative to run each of the above mentioned and other operations.

The above and other features will become more readily apparent from the detailed description of the invention in conjunction with the wing drawings.

### BRIEF DESCRIPTION OF THE DRAWINGS

FIG. 1A is a perspective view of the inventive ultrasonic cleaner;

FIGS. 1B-1E illustrate a control panel of the cleaner of FIG. 1A as seen during the language selection operation, time selection operation, date selection operation and default operation, respectively, of the ultrasonic cleaner of FIG. 1A;

FIG. 2 is a flowchart illustrating the solution setup and control operation of the ultrasonic cleaner of FIG. 1A;

FIG. 3 is a flowchart illustrating the time, solution, and date set up operations of the ultrasonic cleaner of FIG. 1A;

FIG. 4 is a flow chart illustrating the cleaning cycle operation of the ultrasonic cleaner of FIG. 1A; and

FIG. 5 is a perspective view of an alternative exterior embodiment of the ultrasonic cleaner of FIG. 1A.

### SPECIFIC DESCRIPTION OF THE INVENTION

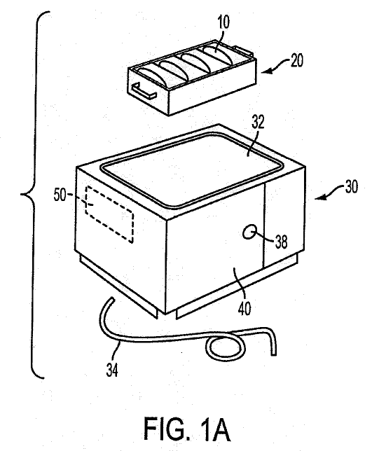

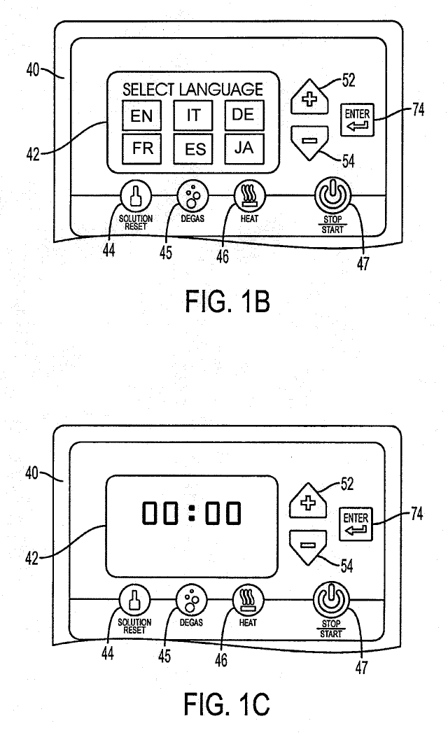

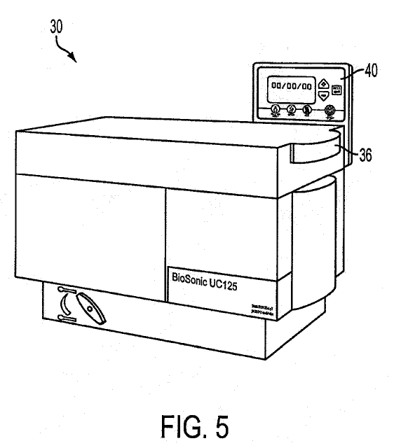

Referring to FIGS. 1A-1E, there is shown an ultrasonic cleaner 30 configured in accordance with the invention. As shown in FIG. 1A, cleaner 30 is configured with a tank or bath 32 fillable with a cleaning solution and removably receiving a cassette or beaker 20 for storing items 10. The tank 32 has a drain outlet tube 34 and a cover (36 shown in FIG. 5) to sealingly close tank 32 when the latter is in use. The cleaner 30 is provided with a control panel 40 mounted to the exterior surface of the cleaner and defining a user interface that allows the operator to interact with device 30 and set the desired parameters, as disclosed hereinafter. The control panel 40 may be disposed on any exterior surface, part, or attachment of the cleaner 30, as shown in FIG. 5. The cleaner 30 also has an electrical generator (not shown) that puts out a high frequency signal causing one or more transducers (not shown) to rapidly induce compression and rarefaction waves in the cleaning solution in tank 32. The one or more transducers may be disposed on the underside of the tank. During the rarefaction cycle the solution is torn apart creating, thus, a vacuum cavity within the solution. When the cavity reaches a certain size based on the frequency and the wattage of the signal, it violently collapses and impacts against items 10 stored in cassette 20.

The control panel 40, better seen in FIGS. 1B-1E, is configured with a display device or screen 42. Preferably, screen 42 is a liquid crystal display device having a liquid crystal material that is sandwiched between two substrates (glass or plastic or any other suitable material). Alternatively, screen 42 may be configured as (O)LED, E-ink, or other known structures of the display device. The front of control panel 40 may further have numerous keys 44, 45, 46, and 47 labeled with respective icons that, in turn, represent respective operations automatically executable by a central processing unit, as also will be explained in detail hereinafter. In addition, the front of control panel 40 has a pair of “+” and “−” control keys 52, 54, respectively, utilized by the operator to set up the desired parameters for at least some of the operations of cleaner 30.

There are many considerations important to ultrasonic cleaning. Optimizing these variables will produce the best results. One of the most important decisions to be made is how frequently the cleaning solution should be changed and/or replenished. The purpose of the solution is to break the bonds between the items to be cleaned and impurities attached thereto. The primary purpose of the ultrasonic activity (cavitation) is to assist the solution in doing its job. For example, increased cavitation levels result from reduced fluid surface tension that is usually observed in clean or freshly filled cleaning solutions. Accordingly, the cleaning solutions should be changed or replenished when a noticeable decrease in cleaning action occurs, or when the solution is visibly dirty or spent. If the solution is not regularly changed or replenished, the effectiveness of the cleaning process rapidly decreases.

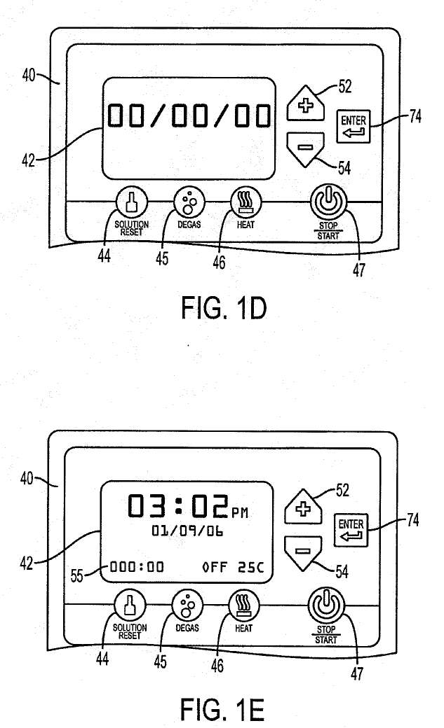

In contrast to the known prior art ultrasonic cleaners, inventive cleaner 30 is provided with a solution timer unit operative to track and indicate the amount of time the cleaning solution has been in use. As shown in FIG. 2, software executed by a central processing unit (CPU) 60 allows the operator to set up a desired solution life-period as indicated by a step 103. Optionally, a timer 55 may be provided to simply indicate the time period the solution has been in the cleaner 30 or to indicate the total usage (or cleaning cycle) time of the solution. To set the desired solution life-period or to start a solution timer, a solution reset button 44, as shown in FIG. 1E, is depressed by the operator. A signal generated as a result of depressing key 44 is received by CPU 60 executing respective software that activates a solution life timer 55 provided on screen 42. It is recommended to change a solution, for example, every 8 hours. Based on the recommended time period, solution life timer 55 may indicate a total time in hours and minutes since a previous solution change—i.e., the previous time the solution reset button 44 is depressed—or it may indicate a count down from the desired period in hours and minutes as a setup parameter on default screen 42. As illustrated by FIG. 1E, the timer 55 is operative to indicate the time elapsed from the beginning of the stored solution life-period or the remaining time counted down from the desired period. The desired time period may be, of course, changed based on the operator's decision. For example, if loads of instruments to be cleaned are relatively insignificant and not excessively dirty, the desired life period may be set for a relatively long period of time and conversely. To actually set up the desired life period, the operator depresses respective key 44 and manipulates keys 52, 54 until the desired hours and minutes are fully indicated by solution life timer 55. The operator may then press enter key 74, solution reset key 44, or stop/start key 47 to start the countdown from the desired life period. Again, alternatively, the operator may simply press solution reset key 44 when new solution is added to cleaner 30 in order to start timer 55 from zero to indicate the time elapsed from the beginning of the stored solution life-period or a cumulative cleaning cycle time of the solution.

Optionally, cleaner 30 is operative to generate a warning signal at a predetermined time corresponding to the end of the set desired time period or at a certain preset time before the set desired time period expires. The warning signal may be a sound signal produced by a unit (not shown) which is mounted to device 30 or by a written message (not shown) which may appear on screen 42. Returning to FIG. 2, CPU 60 receiving a signal from timer 55 is operative to store the set desired time period. The CPU 60 may be operative to selectively monitor the set up time only when cleaner 30 is in a cleaning mode, during which the solution performs the cleaning of the instrument, or start counting down the set up time regardless of whether cleaner 30 operates in the cleaning mode or not. In any case, CPU 60 is operative to monitor the running time and compare it to the stored time, as indicated by step 105. Once the time period has expired or reached a predetermined time threshold, CPU 60 is operative to generate sound and/or written signals 107, respectively.

Optionally, ultrasonic cleaner 30 is operative to automatically change solution. A solution changing unit 50, which is diagrammatically illustrated in FIG. 1A, is configured with a pump, one or more valves (not shown) and drain outlet/inlet tube 34. If it is determined that device 30 is not operating in a cleaning cycle mode by a step 109 in FIG. 2, CPU 60 is operative to execute respective software automatically actuating the pump and valves and as indicated by a step 111 of FIG. 2. A solution level sensor (not shown) detects when the remaining solution reaches the low threshold level and generates a signal reversing the rotational direction of the pump. The desired upper solution level should always be maintained in the tank, particularly with trays or beakers installed. The ultrasonic cleaner 30 is a “tuned” system. Improper solution levels may change the characteristics of the environment, affect the system frequency, decrease effectiveness, and potentially damage the cleaner. Maintaining the proper upper solution level provides for the optimum circulation of the solution around the parts, and protects heaters and transducers from overheating or stress. Once the desired upper solution level is reached, which may be detected by an appropriate sensor (not shown) in a step 113 of FIG. 2, the pump is stopped and the refilling process is complete. If the cleaning cycle is running, device 30 is operative to wait until it is over, as indicated by a step 109 of FIG. 2 and, then, initiate the draining/refilling process of step 111. The operator may always change the previously set solution life period by pressing an enter key 74 (FIG. 1E), and after depressing solution reset button 44, change the duration of the life period as explained above. Unless changed by the operator, the duration of the life period is stored in the memory of CPU 60 and may be automatically reset every time the refilling process is over.

After the cleaning solution has been replenished, CPU 60 may receive a signal from degas key/button 45, which is depressed by the operator, indicating that the operator wishes to degas the solution, which is executed by a step 115 of FIG. 2. “Degassing” is the removal of gases present in the solution which leaves a vacuum in the formed bubble and leads to the effective cavitation. When the high pressure wave hits the bubble wall, the bubble collapses; it is the energy released by this collapse that will assist solution in breaking the bonds between items to be cleaned and impurities. The CPU 60 executes respective software that initially provides the operator with, for example, four zeros or 5 minutes appearing on screen 42 of FIG. 1C. The digits may be grouped, for example, in two two-zero combinations which, in response to the operator's input via “+” and “−” keys 52, 54, respectively, are appropriately changed to represent the desired degassing time period, which will be stored in the memory of CPU 60. The selection may be in increments of 5 minutes for each input using the “+” and “−” keys 52, 54, and up to 15 minutes for the degassing time period. Degassing may default to a time of 5 minutes. For example, if enter key 74 is pressed, a “5” may flash and allow the user to press “+” and “−” keys 52, 54 to increment as high as 15 minutes. Pressing enter key 74 may then accept the new time and save it as the new default. Otherwise, pressing a stop/start key 47 after incrementing to the new time may simply start the degassing process while maintaining the default time period at 5 minutes or a previously-set default time. A “Degas Complete” message may be displayed when degassing is completed over the selected time.

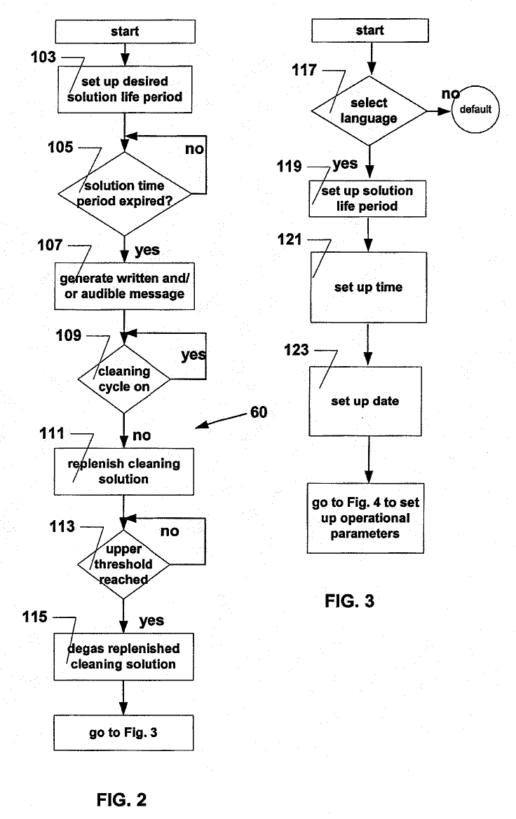

Other setup parameters include a language, time and date. Referring to FIGS. 1B and 3, after the operator turns on cleaner 30, multiple language codes representing respective languages appear on screen 42. The operator may select the desired language by touching a respective icon, such as “US” representing American English, or by scrolling between selections using “+” and “−” keys 52, 54. Having selected the language, the operator depresses enter key 74. The CPU 60 responds to the operator's selection by storing the selected language and executing software that ensures that further communication with cleaner 30 including written and auditory instructions will be presented in the selected language, as indicated by a step 117 in FIG. 3. While only six languages are shown in FIG. 1B, obviously, cleaner 30 may be operated in more or less than six languages. If CPU 60 does not receive the operator's input, it may automatically provide further communication in the language of the country where cleaner 30 is manufactured or it may require the operator to enter a selected language.

After executing the setup solution life period, as indicated by a step 119 of FIG. 3, the setup procedure further includes setting up the time, as illustrated in FIG. 1C and executed by a step 121 in FIG. 3. The setting of the clock includes appearance of four zeroes on screen 42. Each zero will flash when selected by the operator who, then, manipulates keys “+” and “−” keys 52, 54, respectively, to set the current time. Upon setting the time, the operator presses enter key 74.

The date setting procedure is executed by CPU 60 by a step 123 of FIG. 3 and illustrated in FIG. 1D. Three two-zero groups representing month, date and year, respectively, appear on screen 42 and, similarly to the previously disclosed time-set procedure, the operator selects and stores the current date. The setup date software is operative to setup the date in either the US/Great Britain Date format (MM/DD/YY) or International Date Format (DD/MM/YY). The setup parameters will always appear on the default screen of FIG. 1E. The setup clock and date parameters may, however, temporarily disappear only when cleaner 30 is in a cleaning mode or when a warning signal, directing the operator's attention to a detected irregularity, such as the expired solution life period, appears on screen 42.

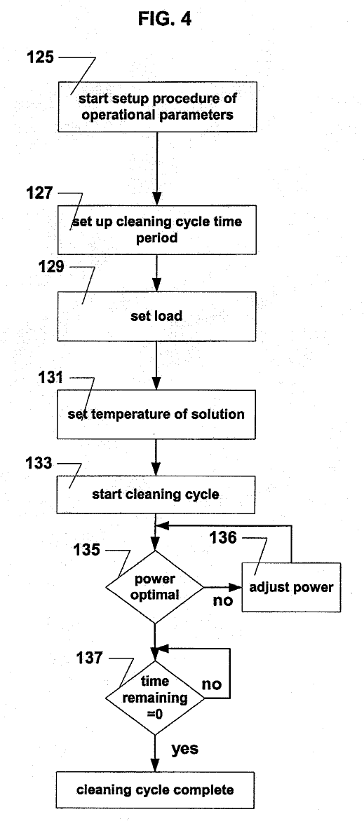

The CPU 60 is further operative to execute software for setting up operational parameters controlling the effectiveness of the cleaning cycle, as indicated by a step 125 of FIG. 4. In response to pressing an appropriate one of keys, for example stop/start key/button 47 as shown in FIG. 1C, screen 42 is lit by two groups of consecutive zeros similar to the setting of a cleaning cycle timer. After “+” and “−” keys 52, 54, respectively, have been utilized by the operator to set the desirable cleaning time period, typically varying between 5 and 60 minutes, enter key 74 is depressed and the cleaning cycle time is stored in the memory of CPU 60, as illustrated by a step 127 of FIG. 4. As cleaner 30 continues to operate in the cleaning mode, the cleaning cycle timer counts down the remaining minutes from the time the operator selected cleaning time. Once the timer reaches zero, as illustrated by a step 137, “Cycle Complete” will be displayed on screen 42 until any of keys 44 is depressed. The screen will then return to the default screen of FIG. 1E. Optionally, if the user presses stop/start button 47 at the default screen, 3 icons may appear indicating default times of 10, 15 and 30 minutes. After an icon is selected, “+” and “−” keys 52, 54 may be used to increase or decease time from 5 to 60 minutes. If enter key 74 is pressed after setting a new time but before starting the cleaning cycle, the new time may be set as the new default for the selected icon. Otherwise, pressing the stop/start button 47 would start the cleaning cycle and run down the set time, while the icon would default back to the previously-set default time for the icon.

Before the cleaning cycle starts in accordance with a step 133 of FIG. 4, CPU 60 may execute software offering the operator the choice of selecting a load, as indicated by a step 129. The load categories may include the items to be cleaned, beakers and cassettes all disclosed in the above-mentioned U.S. Pat. No. 4,903,718 fully incorporated herein by reference. The load is one of the important factors affecting the efficiency of the cleaning process. The above mentioned load categories may be shown on screen 42 upon pressing enter key 74, as shown in any of FIG. 1C, and can be selected by manipulating “+” and “−” keys 52, 54, respectively. Once the desired load category is selected, it is stored in the memory of CPU 60 in response to the pressing of enter key 72 by the operator.

The cleaning efficiency of cleaner 30 also depends on elevated temperatures which usually enhance and accelerate the cleaning process. The cleaner 30 may be equipped with a heater (not shown) that can effectively warm up a cleaning solution in response to an operator-set temperature, as indicated by a step 131 in FIG. 4. To adjust the temperature, the operator may press a respective “HEAT” key 46 that causes CPU 60 to execute software for establishing the desire temperature. Initially, a written message on screen 42 or an audible message will prompt the operator to select between Celsius or Fahrenheit scales. If the message appears on screen 42, it will show “C” for Celsius and “F” for Fahrenheit. To change the temperature scale, key 46 or keys 52,54 may be pressed for a predetermined period of time and then the correct scale is selected. After selecting the temperature scale and pressing the stop/start button 47, the operator uses “+” and “−” keys 52, 54, respectively, to set the desired temperature. In response to pressing enter key 74 or stop/start key 47, the temperature is stored in the memory of CPU 60. Only after the desired temperature has been reached, the “OK” sign will be displayed on screen 42 and the cleaning cycle will start. The selected temperature will be shown on default screen 42 of FIG. 1E.

Due to relatively high temperatures used, the cleaning solution tends to evaporate. Since low solution levels can seriously damage cleaner 30, CPU 60 may be operative to execute software either reminding the operator to turn off cleaner 30 after the cleaning cycle is completed or do it automatically.

The above disclosed sequence of operations does not have to be necessarily in the order described above. For example, the load selection operation may be executed first. Alternatively, the temperature selection operation can be completed first.

Finally, the cleaning ability of a cleaner depends on actual electrical power input. Typically, dependent on the cleaning application, the power requirements may be calculated using the following formula:

L(in)×W(in)×(H−2″)/231*1000=Avg.

Wherein, L, W and H are the length, width and height of the cleaner's tank, respectively, and Avg is the average power. The cleaner 30 may be optionally provided with a power intensity control button 38, as shown in FIG. 1A. The control button 38 adjusts the wattage of the ultrasonic energy to any desired level, as shown by steps 135 and 137, and, thus, increases the effectiveness of the cleaning process.

The specific features described herein may be used in some embodiments, but not in others, without departure from the spirit and scope of the invention as set forth. Many additional modifications are intended in the foregoing disclosure, and it will be appreciated by those of ordinary skill in the art that in some instances some features of the invention will be employed in the absence of a corresponding use of other features. The illustrative examples, therefore, do not limit the invention to the specific embodiments described, and the invention includes modifications to these embodiments that do not depart from the spirit and scope of the invention.

The invention claimed is:

1. An ultrasonic cleaning apparatus that limits a cleaning cycle, and thus a power consumption thereof, and restricts overuse of a cleaning solution, said ultrasonic cleaning apparatus comprising:
an enclosure for housing items to be cleaned during the cleaning cycle in a bath of the cleaning solution;
a transducer for inducing compression and rarefaction waves in the bath of the cleaning solution during the cleaning cycle;
a user interface for selecting a distinct time setting for the cleaning cycle; and
a controller operable to control the ultrasonic cleaning apparatus by
limiting the cleaning cycle to a time period corresponding to the selected distinct time setting,
indicating via the user interface a completion of the cleaning cycle, and
tracking a cumulative usage time of the cleaning solution.

2. The ultrasonic cleaning apparatus of claim 1, further comprising a heater for heating the bath of the cleaning solution during the cleaning cycle.

3. The ultrasonic cleaning apparatus of claim 2, wherein the user interface further provides for inputting a temperature at which the controller and the heater maintain the bath during the cleaning cycle.

4. The ultrasonic cleaning apparatus of claim 1, wherein the user interface further provides for inputting a load category of the items to be cleaned, and the controller controls the cleaning cycle based on the inputted load category.

5. The ultrasonic cleaning apparatus of claim 1, further comprising a drain and a pump controlled by said controller for draining the cleaning solution from the enclosure and applying new cleaning solution to the enclosure.

6. The ultrasonic cleaning apparatus of claim 5, wherein the controller controls the drain and the pump based on the tracked cumulative usage time of the cleaning solution.

7. The ultrasonic cleaning apparatus of claim 6, wherein the controller controls the drain and the pump to maintain an optimal solution level in the enclosure for the bath.

8. The ultrasonic cleaning apparatus of claim 1, wherein the user interface further provides for inputting a degassing time period and the controller controls the transducer to degas the cleaning solution in the enclosure over the degassing time period.

9. The ultrasonic cleaning apparatus of claim 1, wherein the controller automatically powers off the ultrasonic cleaning apparatus after a predetermined period of non-use.

10. The ultrasonic cleaning apparatus of claim 1, wherein the user interface is provided in one of multiple selectable languages.

11. The ultrasonic cleaning apparatus of claim 1, wherein the user interface further provides for inputting one or more of the distinct time setting, each between 5 and 60 minutes, for selection.

12. An ultrasonic cleaning apparatus that limits a cleaning cycle, and thus a power consumption thereof, and restricts overuse of a cleaning solution, said ultrasonic cleaning apparatus comprising:
means for housing items to be cleaned during the cleaning cycle in a bath of the cleaning solution;
mean for inducing compression and rarefaction waves in the bath of the cleaning solution during the cleaning cycle;
means for selecting a distinct time setting for the cleaning cycle;
means for limiting the cleaning cycle to a time period corresponding to the selected distinct time setting;
means for indicating a completion of the cleaning cycle; and
means for tracking a cumulative usage time of the cleaning solution.

13. The ultrasonic cleaning apparatus of claim 12, further comprising means for heating the bath of the cleaning solution during the cleaning cycle.

14. The ultrasonic cleaning apparatus of claim 12, further comprising means for inputting a temperature at which to maintain the bath during the cleaning cycle.

15. The ultrasonic cleaning apparatus of claim 12, further comprising means for inputting a load category of the items to be cleaned and controlling the cleaning cycle based on the inputted load category.

16. The ultrasonic cleaning apparatus of claim 12, further comprising:
means for draining the cleaning solution from the housing means; and
means for applying new cleaning solution to the housing means.

17. The ultrasonic cleaning apparatus of claim 16, further comprising means for controlling the draining means and the applying means based on the tracked cumulative usage time of the cleaning solution

18. The ultrasonic cleaning apparatus of claim 17, wherein the controlling means controls the draining means and the applying means to maintain an optimal solution level in the housing means for the bath.

19. The ultrasonic cleaning apparatus of claim 12, further comprising means for inputting a degassing time period over which the inducing means degasses the cleaning solution in the housing means.

20. The ultrasonic cleaning apparatus of claim 12, further comprising means for automatically powering off the ultrasonic cleaning apparatus after a predetermined period of non-use.

21. The ultrasonic cleaning apparatus of claim 12, wherein the selecting means is provided in one of multiple selectable languages.

22. The ultrasonic cleaning apparatus of claim 12, further comprising means for inputting one or more of the distinct time setting, each between 5 and 60 minutes, for selection.

23. An ultrasonic cleaning method that limits a cleaning cycle, and thus a power consumption thereof, and restricts overuse of a cleaning solution, said ultrasonic cleaning method comprising the steps of:
housing items to be cleaned during the cleaning cycle in a bath of the cleaning solution;
inducing compression and rarefaction waves in the bath of the cleaning solution during the cleaning cycle;
selecting a distinct time setting for the cleaning cycle;
limiting the cleaning cycle to a time period corresponding to the selected distinct time setting;
indicating a completion of the cleaning cycle; and
tracking a cumulative usage time of the cleaning solution.

24. The ultrasonic cleaning method of claim 23, further comprising the step of heating the bath of the cleaning solution during the cleaning cycle.

25. The ultrasonic cleaning method of claim 24, further comprising the step of inputting a temperature at which to maintain the bath during the cleaning cycle.

26. The ultrasonic cleaning method of claim 23, further comprising the steps of:
inputting a load category of the items to be cleaned; and
controlling the cleaning cycle based on the inputted load category.

27. The ultrasonic cleaning method of claim 23, further comprising the steps of:
draining the cleaning solution from the bath; and
applying new cleaning solution to the bath.

28. The ultrasonic cleaning method of claim 27, further comprising the step of controlling the draining and applying steps based on the tracked cumulative usage time of the cleaning solution.

29. The ultrasonic cleaning method of claim 28, further comprising the step of maintaining an optimal solution level for the bath by controlling the draining and applying steps.

30. The ultrasonic cleaning method of claim 23, further comprising the steps of:
inputting a degassing time period; and
degassing the cleaning solution in the bath over the degassing time period.

31. The ultrasonic cleaning method of claim 23, further comprising the step of automatically powering off an apparatus for carrying out the ultrasonic cleaning method after a predetermined period of non-use.

32. The ultrasonic cleaning method of claim 23, further comprising the step of selecting one of multiple languages for the distinct time setting selecting step.

33. The ultrasonic cleaning method of claim 23, further comprising the step of inputting one or more of the distinct time setting, each between 5 and 60 minutes, for selection.
